(19) United States
(12) Patent Application Publication
(10) Pub. No.: US 2010/0262910 A1
(43) Pub. Date: Oct. 14, 2010

(54) METHOD AND APPARATUS FOR PROCESSING VIRTUAL IMAGE FILES

(75) Inventors: Hae-sik JUN, Seoul (KR); Jun-ho JANG, Hwaseong-si (KR); Jung-jin KIM, Anyang-si (KR); Young-suk KIM, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/644,395

(22) Filed: Dec. 22, 2009

(30) Foreign Application Priority Data
Apr. 8, 2009 (KR) 10-2009-0030512

(51) Int. Cl. G06F 3/048; G06F 9/54

(52) U.S. Cl. 715/716; 719/328

(57) ABSTRACT

Provided is a method of processing virtual image files, the method including displaying a file list, receiving an input for selecting a virtual image file or a title from the file list, and extracting and playing back the selected virtual image file or the selected title.

### CROSS-REFERENCE TO RELATED PATENT APPLICATION

This application claims priority from Korean Patent Application No. 10-2009-0030512, filed Apr. 8, 2009, in the Korean Intellectual Property Office, the disclosure of which is incorporated herein in its entirety by reference.

### BACKGROUND

1. Field

Apparatuses and methods consistent with the inventive concept relate to processing virtual image files, and more particularly, to processing virtual image files enabling information recorded in a recording medium to be used without having to insert the recording medium into a playback device.

2. Description of the Related Art

A Blu-ray Disc (BD) Live service is a function using a BD medium that, when a BD supporting the function of the BD-Live service is loaded into a BD playback device, a BD-Java (BD-J) application is launched to perform functions, such as downloading latest trailers or accessing a portal site of a creator of a game or of a content of the BD.

Content of a disc, which is created by a specific disc content creator, may be loaded into a playback device for downloading predetermined information from an external server by using a BD-Live service. However, it is inconvenient for a user to find disc content created by a specific creator and load the disc into a playback device whenever the user wants to use the BD-Live service.

### SUMMARY

Exemplary embodiments may address at least the above problems and/or disadvantages and other disadvantages not described above. Also, exemplary embodiments are not required to overcome the disadvantages described above, and an exemplary embodiment may not overcome any of the problems described above.

According to one or more exemplary embodiments, there is provided a method and apparatus for processing virtual image files enabling information recorded in a recording medium to be used without having to insert the recording medium into a playback device.

According to an aspect of an exemplary embodiment, there is provided a method of processing virtual image files, the method including displaying a file list including a number of virtual image files and titles; receiving an input for selecting one virtual image file or one title from the file list; extracting and playing back the selected virtual image file or the selected title, wherein the virtual image file is data recorded in a medium and is generated as an image file.

The method may further include generating the file list, wherein one or more virtual image files may be stored in an external memory device inserted into an apparatus for performing the method, and the file list may be information for displaying the one or more virtual image files stored in the external memory device or one or more titles in the virtual image file.

Furthermore, the method may further include storing one or more virtual image files in an apparatus for performing the method; and generating the file list, wherein the file list may be information for displaying the one or more virtual image files or one or more titles stored in the apparatus.

Furthermore, the generating of the file list may include generating the list of the virtual image files based on additional information regarding data recorded in the medium. Furthermore, when the one virtual image file is selected and the selected virtual image file includes a plurality of titles, the playing back of the selected virtual image file or the selected title may include playing back the plurality of titles in the selected virtual image file in sequence.

Furthermore, the method may further include receiving an input for setting up a point of time to play back the selected virtual image file or the selected title, wherein the selected virtual image file or the selected title may be played back at the set point of time. Furthermore, the method may further include, when a virtual image file or a title other than the selected virtual image file or the selected title is being executed, terminating the virtual image file or the title which is being executed, prior to the playing back of the selected virtual image file or the selected title.

According to another aspect of an exemplary embodiment, there is provided a method of processing virtual image files, the method including storing a virtual image file in a playback device; and playing back the virtual image file stored in the playback device, wherein the virtual image file is data recorded in a medium and is generated as an image file.

The storing of the virtual image file may include dividing the virtual image file into a plurality of files and storing the plurality of files. Furthermore, the storing of the virtual image file may include, when a medium, in which the virtual image file and a Java application are recorded, is loaded into the playback device, storing the virtual image file in the playback device by using a virtual image file storing application programming interface (API) included in the Java application. Furthermore, the storing of the virtual image file may include, when a medium, in which a Java application is recorded, is loaded into the playback device, downloading the virtual image file to the playback device via a communication network by using a virtual image file downloading API included in the Java application. Furthermore, the storing of the virtual image file may include storing the virtual image file in a local storage unit of the playback device.

Furthermore, the storing of the virtual image file may include storing the virtual image file at a predetermined location in the local storage unit according to a predetermined criterion based on additional information regarding data recorded in the medium.

According to another aspect of an exemplary embodiment, there is provided a medium having recorded thereon a virtual image file and a Java application, which includes a virtual image file storing API instructing to store the virtual image file in a playback device.

According to another aspect of an exemplary embodiment, there is provided a medium having recorded thereon a Java application, which includes a virtual image file downloading API instructing to download a virtual image file via a communication network.

According to another aspect of an exemplary embodiment, there is provided an apparatus for processing virtual image files, the apparatus including a signal processing unit which plays back virtual image files or titles, wherein a virtual image file includes data recorded in a medium and is generated as an image file.

According to another aspect of an exemplary embodiment, there is provided an apparatus for processing virtual image files, the apparatus including a local storage unit for storing a virtual image file; and a signal processing unit which plays back the virtual image file stored in the local storage unit, wherein the virtual image file is data recorded in a medium and is generated as an image file.

According to another aspect of an exemplary embodiment, there is provided a computer-readable recording medium having recorded thereon the program for performing a method of processing virtual image files, the method including displaying a file list including a number of virtual image files and titles; receiving an input for selecting one virtual image file or one title from the file list; extracting and playing back the selected virtual image file or the selected title, wherein the virtual image file is data recorded in a medium and is generated as an image file.

According to another aspect of an exemplary embodiment, there is provided a computer-readable recording medium having recorded thereon the program for performing a method of processing virtual image files, the method including storing a virtual image file in a playback device; and playing back the virtual image file stored in the playback device, wherein the virtual image file is data recorded in a medium and is generated as an image file.

### BRIEF DESCRIPTION OF THE DRAWINGS

The above and other aspects will become more apparent by describing in certain exemplary embodiments with reference to the accompanying drawings, in which:

FIG. 1 is a diagram for describing various methods of storing data recorded in a medium in a playback device according to an exemplary embodiment;

FIG. 2 is a block diagram of a playback device according to an exemplary embodiment;

FIG. 3 is a diagram showing additional information according to an exemplary embodiment;

FIG. 4 is a diagram showing the structures of virtual image files stored in a local storage unit, according to an exemplary embodiment;

FIG. 5 shows a screen on which a file list generated according to types of titles is displayed, according to an exemplary embodiment;

FIG. 6 shows a screen on which a file list generated based on virtual image files is displayed, according to another exemplary embodiment;

FIG. 7 shows a screen on which a file list generated based on virtual image files is displayed, according to another exemplary embodiment; and

FIG. 8 is a flowchart of a method of processing virtual image files, according to an exemplary embodiment.

### DETAILED DESCRIPTION

Certain exemplary embodiments described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

For a playback device to playback predetermined data without a physical medium in which the data is recorded, for performing a BD-Live service, an exemplary embodiment records the data recorded in the physical medium in the playback device in advance. Accordingly, it is possible to perform the BD-Live service by playing back the data recorded in the physical medium without loading the physical medium into a playback device.

For example, data recorded in an actual physical recording medium may be used to generate an image file that can be used in a playback device, such as a computer. Such an image file is referred to as a virtual image file. A virtual image file is a single file which contains the complete contents and structure of data in an actual physical recording medium. By using a virtual image file, data which is the same data as data recorded in a physical recording medium may be utilized without the actual physical recording medium.

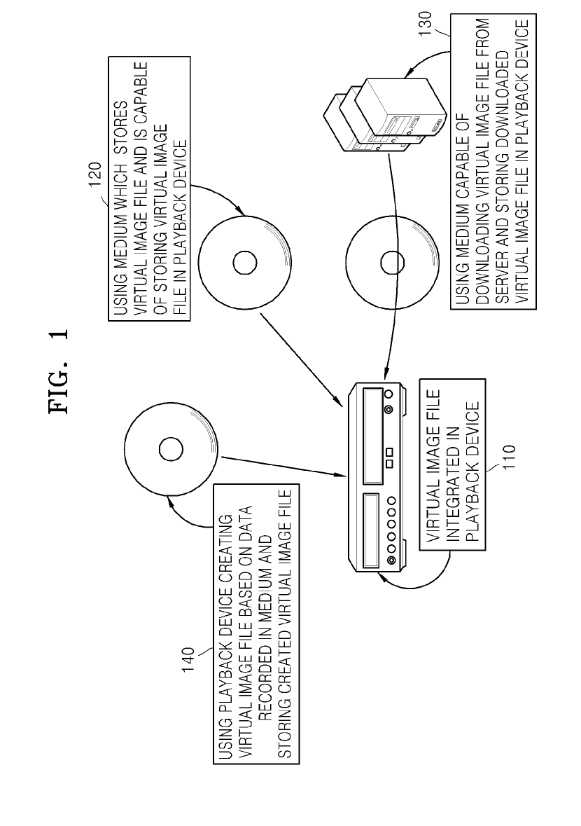

FIG. 1 is a diagram for describing methods of storing data recorded in a medium in a playback device according to an exemplary embodiment.

According to an exemplary embodiment, data to be played back without a physical medium is stored in the form of a virtual image file in a playback device so that the data to be played back without a physical medium may become a BD-J. Title. The BD-J Title refers to a title in which audio data, video data, and graphic data that are played back by a Java program are recorded.

A disc content creator generates a BD-J Title to be played back without a physical disc according to a general BD-ROM format, and creates disc content in which one or more BD-J Titles are recorded in a virtual disc-type image file. A disc content creator generates one virtual image file with respect to one medium in which one or more titles are recorded. The virtual image file may be an ISO file, for example. A virtual image file with respect to a medium may be divided into a plurality of files and recorded in the medium.

An example of a method of storing data which is recorded in a medium in a playback device, as shown in FIG. 1, is a method 110 in which the manufacturer of a playback device stores a virtual image file in the playback device when the playback device is manufactured. The manufacturer may generate a virtual image file before the playback device is released, store the virtual image file in a playback device, and sell the playback device in which the virtual image file is recorded, to a user. In this case, the playback device already stores data, which is recorded in a medium in the form of a virtual image file before the playback device is released. Alternatively, the manufacturer of a playback device may store the virtual image files in a predetermined memory device, such as a USB memory device, and provide the memory device together with the playback device to the user. In this case, the user may use the virtual image file stored in the memory device by inserting the memory device, in which the virtual image file is stored, into the playback device.

Accordingly, a playback device may play back a virtual image file, which is stored in either the playback device or the memory device, even if a physical disc is not loaded into the playback device.

An example of another method of storing data which is recorded in a medium in a playback device, as shown in FIG. 1, is a method 120 that uses a medium which includes a virtual image file and is capable of storing the virtual image file in a playback device.

A disc content creator generates a virtual image file with respect to data recorded in a medium, and records the generated virtual image file in the medium together with a Java application including a virtual image file storing application programming interface (API). When the BD is loaded into a playback device, a Java module reads a virtual image file which is recorded in the medium via the virtual image file storing API loaded by the Java application, and stores the virtual image file in the playback device according to the loaded API.

An example of another method of storing data which is recorded in a medium in a playback device, as shown in FIG. 1, is a method 130 that uses a medium capable of downloading a virtual image file from a server and storing the downloaded virtual image file in a playback device.

A disc content creator generates a virtual image file with respect to data recorded in a medium and stores the generated virtual image in a predetermined server. Furthermore, the disc content creator records a Java application including a virtual image file downloading API in the predetermined BD. When the BD is loaded into a playback device, a Java module downloads a virtual image file from an external server via the virtual image file downloading API loaded by the Java application, and stores the downloaded virtual image file in the playback device.

An example of another method of storing data which is recorded in a medium in a playback device, as shown in FIG. 1, is a method 140 in which a playback device itself generates a virtual image file and stores the generated virtual image file with respect to the data recorded in the medium. According to the method, when a medium in which predetermined data is recorded is loaded into a playback device, the playback device itself generates a virtual image file with respect to the data, and stores the generated virtual image file in the playback device.

As described above, according to exemplary embodiments, a virtual image file stored in a playback device may be played back without a medium in which a title is recorded, by generating the virtual image file with respect to the title and storing the generated virtual image file in the playback device.

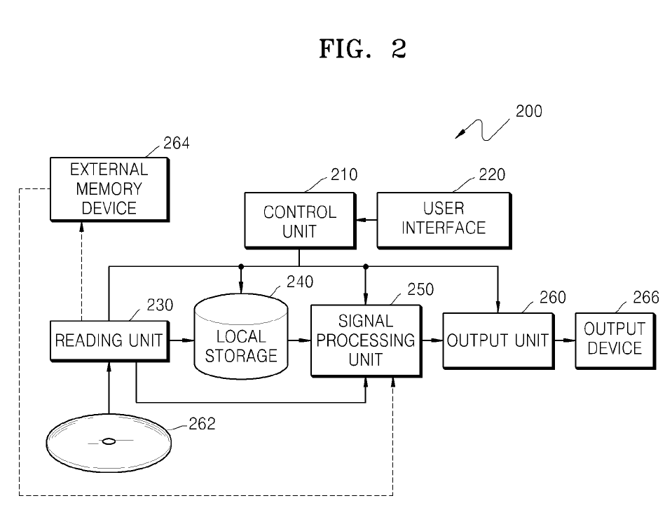

FIG. 2 is a block diagram of a playback device 200 according to an exemplary embodiment. Referring to FIG. 2, the playback device 200 includes a control unit 210, a user interface 220, a reading unit 230, a local storage unit 240, a signal processing unit 250, and an output unit 260.

When a medium 262 is loaded into the playback device 200, the reading unit 230 reads data from the medium 262, and sends the read data to the local storage unit 240 or the signal processing unit 250.

The local storage unit 240 may store data downloaded from an external server (not shown) via a wired or a wireless communication network or may store data recorded in the medium 262 loaded into the playback device 200. According to an exemplary embodiment, one or more virtual image files may be stored in the local storage unit 240 by using various methods. Alternatively, the playback device 200 may store data in an external memory device 264. When the external memory device 264, such as a USB memory device, is inserted into the playback device 200, the playback device 200 may store data downloaded from an external server or data recorded in the medium 262 loaded in the playback device 200 in the external memory device 264. Furthermore, the playback device 200 may also store a virtual image file in the external memory device 264.

When the external memory device 264 in which a virtual image file is stored is inserted into the playback device 200, the playback device 200 may play back the virtual image file stored in the external memory device 264.

The local storage unit 240 or the external memory device 264 may store virtual image files at a predetermined location according to a predetermined criterion based on an additional information regarding data recorded in the medium 262. Additional information regarding data recorded in the medium 262 is information for describing the data stored in the medium 262, and may include a disc content creator ID, a title ID, and a description regarding a title. Additional information may be stored in the same medium as the predetermined data to be described by the additional information or may be stored in a different medium or a different external server separately from where the data is stored.

The signal processing unit 250 restores desired signals from the data read by the reading unit 230 from the medium 262 or from the data stored in the local storage unit 240 or the external memory device 264 by decoding the data, and sends the restored signals to the output unit 260.

The signal processing unit 250 extracts a predetermined virtual image or a predetermined title selected by a user via the user interface 220 from the local storage unit 240 or from the external memory device 264, and plays back the extracted virtual image file or the extracted title. In the case where the predetermined title is selected by a user, the signal processing unit 250 searches for a virtual image file including the selected title, extracts the selected title in the virtual image file from the local storage unit 240 or from the external memory device 264, and plays back the extracted title. In the case where a virtual image file is selected by a user and the selected virtual image file includes a plurality of titles, the signal processing unit 250 may play back the titles in the selected virtual image file 250 in a sequence.

When a virtual image file or a title other than a virtual image file or a title selected by a user is currently being executed, the signal processing unit 250 terminates the virtual image file or the title currently being executed, and plays back the virtual image file or the title selected by the user.

The signal processing unit 250 may include a Java module which processes data according to a predetermined API included in a Java application. When a medium, in which a virtual image file and a Java application including a virtual image file storing API are recorded, is loaded, the Java module may store the virtual image file recorded in the medium in the local storage unit 240 or in the external memory device 264 by using the virtual image file storing API included in the Java application. Furthermore, when a medium, in which a Java application including a virtual image file downloading API are recorded, is loaded, the Java module may download a virtual image file stored in an external server via a communication network by using the virtual image file downloading API included in Java application and store the downloaded virtual image file in the local storage unit 240 or in the external memory device 264.

A user may request, by using the user interface 220, to play back a predetermined virtual image file or a predetermined title at a specific point of time. In this case, the signal processing unit 250 plays back a selected virtual image file or a selected title at the point of time requested by the user.

The control unit 210 controls the playback device 200 to perform processing virtual image files according to an exemplary embodiment. When a user requests, by using the user interface 220, the playback device 200 to play back a predetermined virtual image file or a predetermined title at a specific point of time, the control unit 210 may control the signal processing unit 250 to perform signal processing at the requested point of time. Furthermore, the control unit 210 may use the additional information to store virtual image files at predetermined locations in the local storage unit 240 or in the external memory device 264 in a sequence.

The control unit 210 includes an arithmetic logic unit (ALU) for performing calculations, and includes a register for temporarily storing data and instruction commands.

The output unit 260 outputs a status of the playback device 200 or information input by a user via the user interface 220 on an output device 266, such as a display screen for displaying video signals, a speaker for outputting audio signals, etc.

In the case where one or more virtual image files are stored in the local storage unit 240 or in the external memory device 264, the output unit 260 may generate a file list for displaying one or more virtual image files or titles included in one or more virtual image files. The output unit 260 may generate the file list with respect to the virtual image files based on additional information regarding data recorded in the medium 262. The output unit 260 may generate the file list categorized in various ways, such as by disc IDs, by title IDs, or by title types. The output unit 260 displays the generated file list on the output device 266, such as the display screen.

A user may select a desired virtual image file or a desired title from the displayed file list by using the user interface 220. Furthermore, a user may set up a point of time to play back a predetermined virtual image or a predetermined title by using the user interface 220. The user interface 220 receives instruction commands, characters, numbers, or voice data from a user via a physical transducer, such as a keyboard, a mouse, a touch pad, a touch screen, or a microphone, and transmits the commands, the characters, the numbers, or the voice data to the control unit 210.

As described above, the playback device 200 according to an exemplary embodiment may store a virtual image file in the playback device 200, and may extract and play back the virtual image file stored in the playback device 200 instead of data recorded in a physical medium.

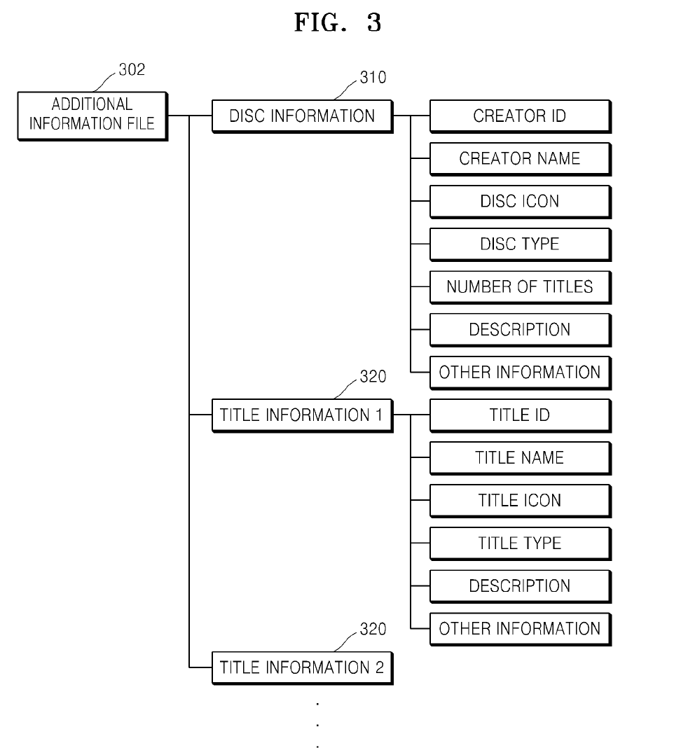

FIG. 3 is a diagram showing the additional information according to an exemplary embodiment. Additional information file 302 includes information for describing data recorded in the medium 262, that is, titles, to be played back without a physical medium or data to be generated as virtual image files. Additional information includes disc information 310 and title information 320. Disc information 310 includes information regarding the disc itself, such as a content creator ID, a disc type, the number of titles etc. The title information 320 includes information regarding each title, such as the title ID, title type, etc.

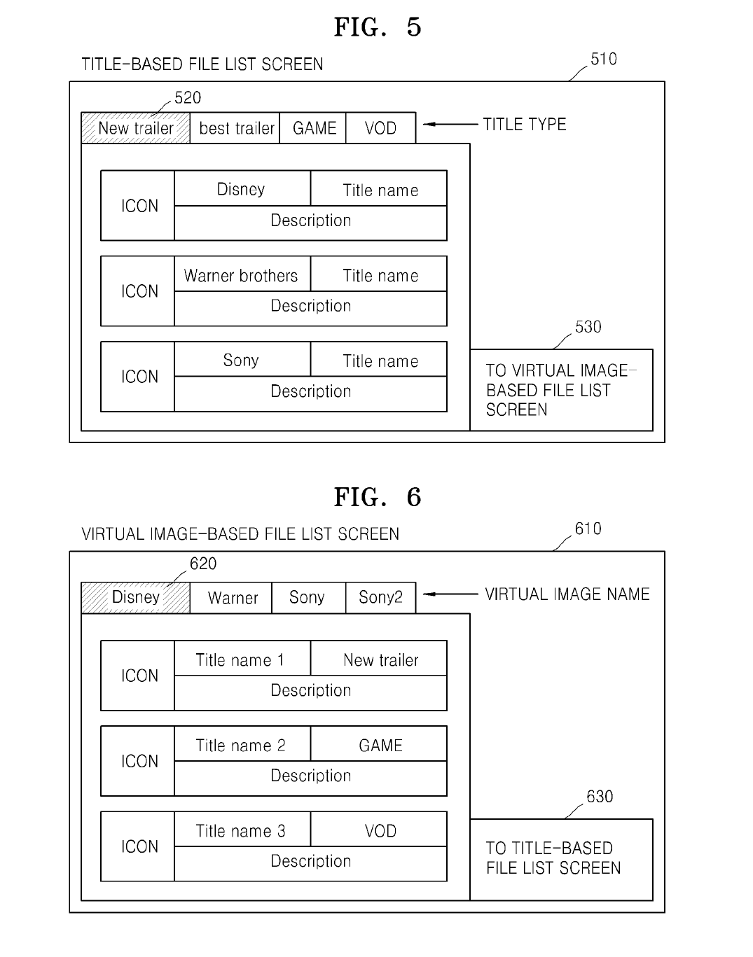

Additional information may be stored in the same medium as the predetermined data to be described by the additional information or may be stored in a medium or an external server separate from where the data is stored. The output unit 260 may generate the file list, in which virtual image files or titles included in each of the virtual image files are classified according to a predetermined criterion, based on the additional information. The file list output by the output unit 260 is described below in detail in reference to FIGS. 5 through 7.

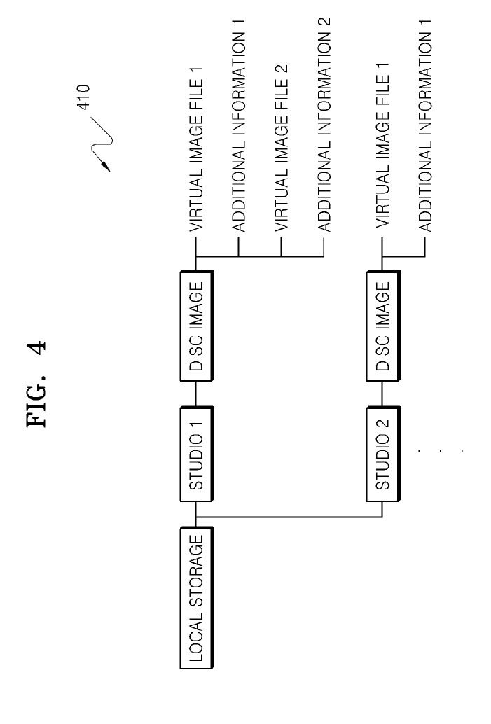

The virtual image files may be stored in the predetermined locations in the local storage unit 240 or in the external memory 264 device according to a predetermined criterion based on the additional information. Locations of virtual image files stored in the local storage unit 240 or the external memory device 264 are described below in reference to FIG. 4.

FIG. 4 is a diagram showing an image directory structure 410 of the virtual image files stored in the local storage unit 240, according to an exemplary embodiment. The control unit 210 refers to the additional information to store the virtual image files in the local storage unit 240 according to a predetermined criterion. Referring to FIG. 4, the local storage unit 240 includes a directory for each of production studios, which are disc content creators, and each studio directory includes a virtual image file directory for storing virtual image files. Virtual image files created by a corresponding studio are stored in a virtual image file directory according to a predetermined criterion, such as a virtual image file ID. In this case, the additional information regarding each virtual image file may be stored together with a corresponding virtual image file. Virtual image files may be stored in the external memory device 264 by using the same method.

FIGS. 5 through 7 are diagrams showing the file lists generated according to exemplary embodiments. One or more virtual image files may be stored in the local storage unit 240 or in the external memory device 264. In the case where a plurality of virtual image files is stored in the local storage unit 240 or in the external memory device 264 and each of the plurality of virtual image files includes a plurality of titles, the output unit 260 may generate the file list categorized by the virtual image files or by the titles.

FIG. 5 shows a display screen 510 on which the file list generated according to the types of the titles is displayed, according to an exemplary embodiment. The output unit 260 may categorize the titles included in the virtual image files by the types of the titles, and may generate the file list according to categorized title type. In FIG. 5, the titles stored in the local storage unit 240 may be categorized into the new trailers, best trailers, game titles, and video on demand (VOD) titles according to the types of the titles. A user may select a desired type of title by using the display screen 510 shown in FIG. 5. In FIG. 5, a selected type of title is the new trailer 520. Accordingly, three titles in the new trailer category are displayed. The three titles are described by the icons respectively indicating the title, studio name, title name, and the additional information regarding each title. A user may select a desired title from the titles categorized as the new trailer, which is the type of title desired by the user, by using the user interface 220.

A button 530 entitled “To Virtual Image File-Based File List Screen” is disposed in the lower right portion of the display screen 510. The button 530 may be selected when a user wants to switch from a title-based file list to a virtual image file-based file list.

FIG. 6 shows a display screen 610 on which the file list generated based on the virtual image files is displayed, according to an exemplary embodiment. In the case where a plurality of virtual image files is stored in the local storage unit 240, the output unit 260 may generate the file list, which identifies the virtual image files, based on the additional information regarding the virtual image files and may output the file list, as shown in FIG. 6. When a user wants a virtual image file corresponding to a medium including content created by Disney, the user may select a virtual image file 620 entitled “Disney.” As shown in FIG. 6, the virtual image file 620 entitled “Disney” includes three titles. The user may operate the user interface 220 to play back one of the predetermined titles included in the virtual image file 620 entitled “Disney.”

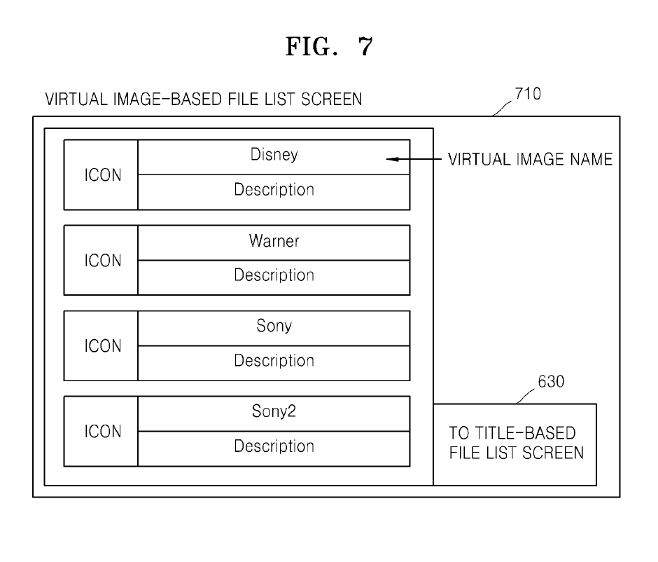

FIG. 7 shows a display screen 710 on which the file list generated based on the virtual image files is displayed, according to an exemplary embodiment. The file list generated based on the virtual image files instead of titles may be generated, as shown in FIG. 7. A user may select a desired virtual image file using the file list displayed, as shown in FIG. 7. Unlike the exemplary embodiment shown in FIG. 6, a user cannot directly select a predetermined title included in a desired virtual image file. Thus, in the case where a virtual image file selected by a user includes a plurality of titles, the signal processing unit 250 plays back the plurality of titles in a sequence.

A button 630 entitled “To Title-Based File List Screen” is disposed in the lower right portion of the display screens 610, 710, shown in FIGS. 6 and 7. The button 630 may be selected when a user wants to switch from a virtual file-based file list to a title-based file list.

As described above, according to exemplary embodiments, the output unit 260 may generate various types of file lists with respect to virtual image files stored in the local storage unit 240 and display the file lists on a screen. Furthermore, a user may select desired information using the file list.

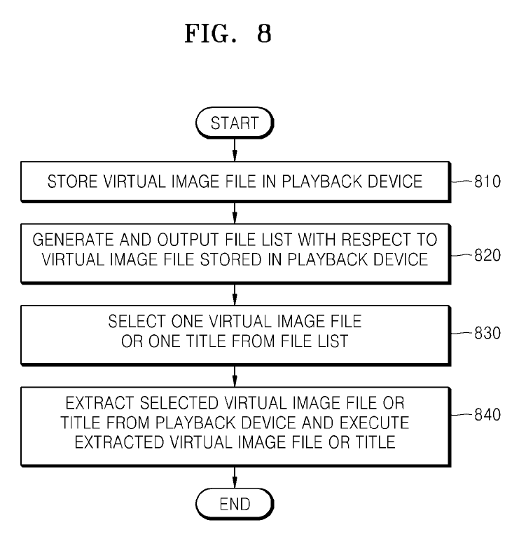

FIG. 8 is a flowchart of a method of processing virtual image files, according to an exemplary embodiment. Referring to FIG. 8, the playback device 200 stores virtual image files in the playback device 200 (operation 810). The playback device 200 may store virtual image files either by using a medium, which stores virtual image files and is capable of storing the virtual image files in the playback device 200, or by using a medium capable of downloading virtual image files from a server and storing the downloaded virtual image files in the playback device 200. When a medium, in which predetermined data is recorded, is loaded, the playback device 200 may generate virtual image files with respect to data recorded in the medium and store the generated virtual image files in the playback device 200.

The playback device 200 generates the file list with respect to the virtual image files stored in the playback device 200 and displays the file list on a screen (operation 820). A user may select a desired virtual image file or a desired title using the file list displayed by the playback device 200 (operation 830). The playback device 200 extracts a predetermined virtual image file or a predetermined title selected by a user from the playback device 200 and plays back the extracted virtual image file or the extracted title (operation 840).

Exemplary embodiments may be implemented as computer programs and implemented in general-use digital computers that execute the programs using a computer-readable recording medium. Examples of the computer-readable recording medium include magnetic storage media (e.g., ROM, floppy disks, hard disks, etc.), optical recording media (e.g., CD-ROMs, or DVDs), and other types of storage media.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method of processing virtual image files, the method comprising:
displaying a file list comprising a list of the virtual image files and titles included in the virtual image files, wherein each of the virtual image files is a file which is generated as an image file for data recorded in a medium;
receiving an input for selecting one of the virtual image files or one of the titles from the file list; and
extracting and playing back the selected virtual image file or the selected title.

2. The method of claim 1, wherein the virtual image files are stored in an external memory device, the method further comprising:
inserting the external memory device into an apparatus and generating the file list prior to the displaying the file list,
wherein the file list includes information for displaying the virtual image files stored in the external memory device or the titles included the virtual image files.

3. The method of claim 1, further comprising:
storing the virtual image files in an apparatus and generating the file list prior to the displaying the file list, wherein the file list includes information for displaying the virtual image files or the titles stored in the apparatus.

4. The method of claim 2, wherein the generating the file list comprises generating the file list based on additional information regarding data recorded in the medium.

5. The method of claim 2, wherein, if the virtual image file is selected and the selected virtual image file comprises a plurality of titles, the playing back of the selected virtual image file or the selected title comprises playing back the plurality of titles of the selected virtual image file in a sequence.

6. The method of claim 1, further comprising:
receiving an input for setting up a point of time to play back the selected virtual image file or the selected title, and
wherein the extracting and playing back the selected virtual image file or the selected title comprises playing back the selected virtual image file or the selected title at the set point of time.

7. The method of claim 1, further comprising, if a virtual image file or a title other than the selected virtual image file or the selected title is being executed, terminating an execution of the virtual image file or the title, prior to the playing back the selected virtual image file or the selected title.

8. A method of processing virtual image files, the method comprising:
storing a virtual image file in a playback device; and
playing back the virtual image file stored in the playback device,
wherein the virtual image file is a file which is generated as an image file for data recorded in a first medium.

9. The method of claim 8, wherein the storing the virtual image file comprises dividing the virtual image file into a plurality of files and storing the plurality of files.

10. The method of claim 8, wherein the storing the virtual image file comprises:
a second medium, in which the virtual image file and a Java application are recorded into the playback device; and
storing the virtual image file in the playback device by using a virtual image file storing application programming interface (API) included in the Java application.

11. The method of claim 8, wherein the storing the virtual image file comprises:
loading a second medium, in which a Java application is recorded, into the playback device; and
downloading the virtual image file to the playback device via a communication network by using a virtual image file downloading API included in the Java application.

12. The method of claim 8, wherein the storing the virtual image file comprises storing the virtual image file in a local storage unit of the playback device.

13. The method of claim 12, wherein the storing the virtual image file comprises storing the virtual image file at a predetermined location in the local storage unit according to a predetermined criterion based on additional information regarding data recorded in the first medium.

14. A medium having recorded thereon a virtual image file and a Java application, which includes a virtual image file storing API instructing to store the virtual image file in a playback device.

15. A medium having recorded thereon a Java application, which includes a virtual image file downloading API instructing to download a virtual image file via a communication network.

16. An apparatus for processing virtual image files, the apparatus comprising a signal processing unit which plays back the virtual image files or titles included in the virtual image files,
wherein each of the virtual image files is a file which is generated as an image file for data recorded in a medium.

17. The apparatus of claim 16, further comprising:
an output unit which generates a file list comprising the virtual image files and the titles and displays the file list; and
a user interface which interfaces with a user to receive an input from the user for selecting one of the virtual image files or one of the titles from the file list.

18. The apparatus of claim 17, wherein the virtual image files are stored in an external memory device to be inserted into the apparatus, and
the file list includes information for displaying the virtual image files stored in the external memory device or the titles included in the virtual image files.

19. The apparatus of claim 17, further comprising a local storage unit which stores the virtual image files,
wherein the file list comprises information for displaying the virtual image files stored in the local storage unit or the titles included in the virtual image files.

20. The apparatus of claim 18, wherein the output unit generates the file list based on additional information regarding data recorded in the medium.

21. The apparatus of claim 18, wherein, if the virtual image file is selected and the selected virtual image file comprises a plurality of titles, the signal processing unit plays back the plurality of titles of the selected virtual image file in a sequence.

22. The apparatus of claim 17, wherein the user interface receives an input for setting up a point of time to play back the selected virtual image file or the selected title, and
the signal processing unit plays back the selected virtual image file or the selected title at the set point of time.

23. The apparatus of claim 17, wherein, if a virtual image file or a title other than the selected virtual image file or the selected title is being executed, the signal processing unit terminates an execution of the virtual image file or the title, prior to the execution of the selected virtual image file or the selected title.

24. An apparatus for processing virtual image files, the apparatus comprising:
a local storage unit which stores a virtual image file; and
a signal processing unit which plays back the virtual image file stored in the local storage unit,
wherein the virtual image file is a file which is generated as an image file for data recorded in a first medium.

25. The apparatus of claim 24, wherein the local storage unit divides the virtual image file into a plurality of files and stores the plurality of files.

26. The apparatus of claim 24, wherein a second medium, in which the virtual image file and a Java application are recorded, is loaded into the apparatus,
the signal processing unit stores the virtual image file in the local storage device by using a virtual image file storing API included in the Java application, and
the signal processing unit comprises a Java module which plays back the virtual image file stored in the local storage unit.

27. The apparatus of claim 24, wherein a second medium, in which a Java application is recorded, is loaded into the apparatus,
the signal processing unit downloads the virtual image file to the local storage unit via a communication network by using a virtual image file downloading API included in the Java application, and
the signal processing unit comprises a Java module which plays back the downloaded virtual image file.

28. The apparatus of claim 27, wherein the local storage unit stores the virtual image file at a predetermined location in the local storage unit according to a predetermined criterion based on additional information regarding data recorded in the first medium.

29. A computer-readable recording medium storing a program which, when executed by a computer, causes the computer to perform a method for processing virtual image files, the method comprising:
displaying a file list comprising a list of the virtual image files and titles included in the virtual image files, wherein each of the virtual image files is a file which is generated as an image file for data recorded in a medium;
receiving an input for selecting one of the virtual image files or one of the titles from the file list;
extracting and playing back the selected virtual image file or the selected title.

30. A computer-readable recording medium storing a program which, when executed by a computer, causes the computer to perform a method for processing virtual image files, the method comprising:
storing a virtual image file in a playback device; and
playing back the virtual image file stored in the playback device,
wherein the virtual image file is a file which is generated as an image file for data recorded in a medium.

31. The method of claim 3, wherein the generating the file list comprises generating the file list based on additional information regarding data recorded in the medium.

32. The method of claim 3, wherein, if the virtual image file is selected and the selected virtual image file comprises a plurality of titles, the playing back of the selected virtual image file comprises playing back the plurality of titles of the selected virtual image file in a sequence.

33. The method of claim 6, further comprising, if a virtual image file or a title other than the selected virtual image file or the selected title is being executed, terminating an execution of the virtual image file or the title, prior to the playing back the selected virtual image file or the selected title.

34. The apparatus of claim 19, wherein the output unit generates the file list based on additional information regarding data recorded in the medium.

35. The apparatus of claim 19, wherein, if the virtual image file is selected and the selected virtual image file comprises a plurality of titles, the signal processing unit plays back the plurality of titles of the selected virtual image file in a sequence.

36. The apparatus of claim 22, wherein, if a virtual image file or a title other than the selected virtual image file or the selected title is being executed, the signal processing unit terminates an execution of the virtual image file or the title, prior to the execution of the selected virtual image file or the selected title.

37. A method comprising:
providing a virtual image file, comprising a file generated as an image file for data recorded in a medium, to a playback device comprising a storage unit;
storing the provided virtual image file in at least one of the storage unit and a removable external memory unit;
generating a list comprising information which facilitates a selection of the virtual image file or a title of the virtual image file based on the stored virtual image file;
displaying the generated list;
receiving an indication of the virtual image file or the title selected from the displayed list;
extracting the selected virtual image file or the selected title from one of the storage unit and the removable external memory unit; and
playing back the selected virtual image file or the selected title.
